(19) United States
(12) Patent Application Publication
(10) Pub. No.: US 2015/0107566 A1
(43) Pub. Date: Apr. 23, 2015

(54) EXHAUST GAS RECIRCULATION DEVICE

(71) Applicant: DENSO CORPORATION, Kariya-city, Aichi-pref. (JP)

(72) Inventors: Yuuki Sugiyama, Nissin-city (JP); Koichi Harada, Okazaki-city (JP)

(21) Appl. No.: 14/398,867

(22) PCT Filed: Apr. 22, 2013
(86) PCT No.: PCT/JP2013/002690

§ 371 Date: Nov. 4, 2014

(30) Foreign Application Priority Data
May 16, 2012 (JP) 2012-112389
Mar. 11, 2013 (JP) 2013-047930

(51) Int. Cl. F02M 25/07; F01P 7/14

(52) U.S. Cl. CPC F02M 25/0737; F01P 7/14; F02M 25/0712
USPC 123/568.12

(57) ABSTRACT

An exhaust gas recirculation (EGR) device includes an EGR passage, a cooling medium circuit, an EGR cooler, and an intercooler. A part of exhaust gas flowing through an exhaust passage of an internal combustion engine is recirculated as EGR gas into an intake passage of the engine through the EGR passage. A cooling medium flows through the cooling medium circuit. The EGR cooler performs a heat exchange between EGR gas flowing through the EGR passage and the cooling medium flowing through the cooling medium circuit so as to cool EGR gas. The intercooler is disposed at the intake passage on a downstream side of a merging part between the intake passage and the EGR passage in a flow direction of intake air, and performs a heat exchange between intake air including EGR gas and flowing through the intake passage, and the cooling medium flowing through the cooling medium circuit so as to cool intake air. The cooling medium circuit is configured independently from a coolant circuit through which coolant for cooling the engine flows. The cooling medium circuit is configured such that at least at time of low-load operation of the engine, the cooling medium which has passed through the EGR cooler flows into the intercooler.

### CROSS REFERENCE TO RELATED APPLICATION

This application is based on Japanese Patent Application No. 2012-112389 filed on May 16, 2012, and Japanese Patent Application No. 2013-47930 filed on Mar. 11, 2013, the disclosures of which are incorporated herein by reference.

1. Technical Field

The present disclosure relates to an exhaust gas recirculation device that recirculates a part of exhaust gas from an internal combustion engine to an intake system.

2. Background Art

Conventionally, there exists an internal combustion engine including a configuration that compresses air drawn into a combustion chamber through a supercharger (turbocharger) and cools the air with an intercooler to improve output by enhancing volumetric efficiency in the combustion chamber (in a cylinder).

In this kind of the internal combustion engine, generally, there is introduced an exhaust gas recirculation (EGR) system (exhaust gas recirculation device) that recirculates a part of exhaust gas into an intake passage to reduce harmful substances (e.g., NOx) contained in exhaust gas.

For such an exhaust gas recirculation device, there are used a high-pressure EGR (HPL-EGR) that recirculates a part of exhaust gas as EGR gas from an upstream side of a filter provided in an exhaust system in a flow direction of gas to an intake system; and a low-pressure EGR (LPL-EGR) that recirculates a part of exhaust gas from a downstream side of the filter provided in the exhaust system in the gas flow direction to the intake system.

Water is contained in large quantity as watery vapor in the EGR gas recirculated from the exhaust system to the intake system of the internal combustion engine. When the low-pressure EGR is used as an exhaust gas recirculation device, the water (watery vapor) in the EGR gas may be condensed at the time of cooling the EGR gas by the intercooler.

Accordingly, there is proposed an exhaust gas recirculation device whereby the EGR gas is cooled by an EGR cooler disposed in an EGR passage of the low-pressure EGR through which the EGR gas flows to condense the water contained in the EGR gas, and cooling capacity of the intercooler is controlled such that the temperature of air after passing through the intercooler is higher than the dew point temperature of air flowing into the intercooler (see, e.g., Patent Document 1).

### PRIOR ART DOCUMENT

### Patent Document

### [Patent Document 1] Japanese Patent No. 4631886

However, the EGR cooler described in Patent Document 1 is configured such that heat is exchanged between high-temperature engine coolant (around 90° C.) whose temperature is elevated in the engine and the EGR gas, and the water contained in the EGR gas can hardly be condensed by the EGR cooler. For this reason, in the exhaust gas recirculation device described in Patent Document 1, the water contained in the EGR gas still may condense at the intercooler, and a defect such as liquid compression in the internal combustion engine, or corrosion of each member may be caused.

As a result of the research study by the present inventors, at the time of low-load operation of the internal combustion engine with a small flow rate of intake air, the condensed water is easily accumulated in the intercooler. The accumulated condensed water enters into the internal combustion engine at once, so that the above defect tends to be more easily caused than at the time of high-load operation.

### SUMMARY OF INVENTION

The present disclosure addresses the above-described issues. Thus, it is an objective of the present disclosure to provide an exhaust gas recirculation device that can restrain an occurrence of a defect caused by condensation of water contained in EGR gas at least at the time of low-load operation of an internal combustion engine.

To achieve the above objective, there is provided an exhaust gas recirculation (EGR) device for an internal combustion engine in one aspect of the present disclosure, including an EGR passage, a cooling medium circuit, an EGR cooler, and an intercooler. A part of exhaust gas flowing through an exhaust passage of the engine is recirculated as EGR gas into an intake passage of the engine through the EGR passage. A cooling medium flows through the cooling medium circuit. The EGR cooler performs a heat exchange between EGR gas flowing through the EGR passage and the cooling medium flowing through the cooling medium circuit so as to cool EGR gas. The intercooler is disposed at the intake passage on a downstream side of a merging part between the intake passage and the EGR passage in a flow direction of intake air, and performs a heat exchange between intake air including EGR gas and flowing through the intake passage, and the cooling medium flowing through the cooling medium circuit so as to cool intake air. The cooling medium circuit is configured independently from a coolant circuit through which coolant for cooling the engine flows. The cooling medium circuit is configured such that at least at time of low-load operation of the engine, the cooling medium which has passed through the EGR cooler flows into the intercooler.

Accordingly, at the EGR cooler, the heat exchange is made between the EGR gas and the low-temperature cooling medium instead of the high-temperature coolant whose temperature is elevated in the internal combustion engine. As a result, the water contained in the EGR gas can be condensed at the EGR cooler.

In addition, at least at the time of low-load operation of the internal combustion engine, at the intercooler, a heat exchange is made between the cooling medium whose temperature is elevated as a result of the absorption of heat from the EGR gas at the EGR cooler, and the intake air including the EGR gas dehumidified at the EGR cooler. Accordingly, the production of condensed water at the intercooler can be limited.

Accordingly, in the present disclosure, the entry of condensed water into the internal combustion engine, which leads to a problem at the time of low-load operation of the internal combustion engine, can be avoided, and an occurrence of a defect caused by the condensation of water contained in the EGR gas can thereby be curbed.

At the time of high-load operation of the internal combustion engine, a flow rate of intake air into the internal combustion engine increases in comparison with at the time of low-load operation, and a flow rate of the EGR gas is accordingly increased. Thus, at the time of high-load operation of the internal combustion engine, if the water contained in the EGR gas is condensed at the EGR cooler, the condensed water existing in the EGR cooler enters easily into the intake passage together with the EGR gas. If the condensed water enters into the intake passage, there is an issue that a liquid compression of the compressor of the supercharger, for example, is caused.

For this reason, the EGR device in another aspect of the present disclosure further includes a cooling capacity adjusting means for adjusting a capacity for cooling EGR gas by the EGR cooler. At time of high-load operation of the engine, the cooling capacity adjusting means reduces the capacity for cooling EGR gas by the EGR cooler as compared to at the time of low-load operation.

In this manner, as a result of the configuration for decreasing the cooling capacity at the EGR cooler at the time of high-load operation of the internal combustion engine, the production of condensed water in the EGR cooler can be limited at the time of high-load operation. Consequently, the entry of the condensed water into the intake passage can be avoided. Thus, the entry of condensed water into the internal combustion engine which leads to concerns at the time of low-load operation of the internal combustion engine can be averted, and the liquid compression of the compressor of the supercharger which becomes problematic at the time of high-load operation of the internal combustion engine, for example, can be prevented.

Therefore, an occurrence of a defect caused by the condensation of water contained in the EGR gas can be restricted even more appropriately.

In addition, The EGR device in yet another aspect of the present disclosure further includes an EGR valve that changes a cross-sectional area of the EGR passage. The EGR cooler is provided on a downstream side of the EGR valve at the EGR passage in a flow direction of EGR gas.

Accordingly, when the EGR passage is closed by the EGR valve, a flow of the EGR gas flowing from the exhaust passage side into the EGR cooler can be prevented. Thus, there can be prevented an unnecessary heat exchange between the EGR gas and the cooling medium at the EGR cooler. As a result, the cooling performance at the intercooler can be ensured.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating general configuration of an engine to which an exhaust gas recirculation device is applied in accordance with a first embodiment;

FIG. 2 is a diagram illustrating general configuration of an engine to which an exhaust gas recirculation device is applied in accordance with a second embodiment;

FIG. 3 is a diagram illustrating general configuration of an engine to which an exhaust gas recirculation device is applied in accordance with a third embodiment;

FIG. 4 is a diagram illustrating general configuration of an engine to which an exhaust gas recirculation device is applied in accordance with a fourth embodiment;

FIG. 5 is a diagram illustrating general configuration of a modification to the exhaust gas recirculation device of the fourth embodiment; and

FIG. 6 is a diagram illustrating general configuration of an engine to which an exhaust gas recirculation device is applied in accordance with a fifth embodiment.

### EMBODIMENTS FOR CARRYING OUT INVENTION

Embodiments will be described below in reference to the drawings. For the same or equivalent component in the following embodiments, its corresponding reference numeral is used in the drawings.

### First Embodiment

An exhaust gas recirculation device in the present embodiment is applied to an engine 1 disposed in a vehicle. This engine 1 is an internal combustion engine of a water-cooled type gasoline engine that constitutes a driving source for vehicle traveling.

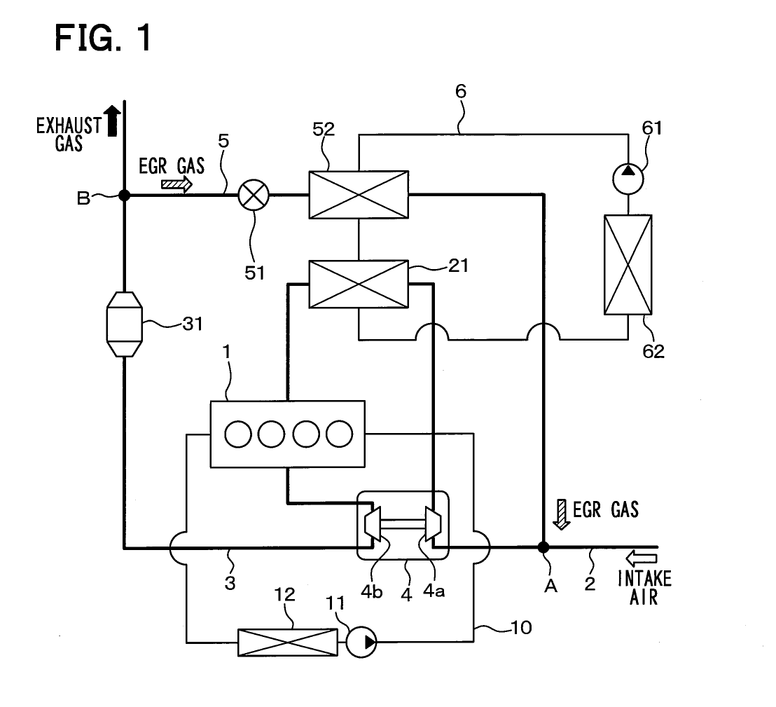

As illustrated in a general configuration diagram in FIG. 1, the engine 1 of the present embodiment is connected to an engine coolant circuit 10 through which engine coolant flows, and is configured to release the heat of the engine 1 to the engine coolant. At the engine coolant circuit 10, there are provided a circulating pump 11 that circulates the engine coolant, and a radiator 12 that makes the engine coolant, whose temperature is elevated in the engine 1, release heat.

An intake passage 2 through which intake air taken in from the outside of the vehicle is guided into a cylinder, and an exhaust passage 3 through which exhaust gas produced in the cylinder (in a combustion chamber) is discharged to the outside of the vehicle are connected to the engine 1.

At the intake passage 2, there are provided a compressor 4a of a supercharger (turbocharger) 4 that operates with the energy of discharged air as its driving source, an intercooler 21 that cools the air having high temperature and high pressure compressed by the compressor 4a in this order from an upstream side in an air flow direction, and so forth.

The supercharger 4 includes the compressor 4a provided at the intake passage 2, and a turbine 4b provided at the exhaust passage 3, and flows the compressed air with high temperature and high pressure to the intercooler 21 on the downstream side.

The intercooler 21 is a heat exchanger through which heat is exchanged between the air with high temperature and high pressure compressed by the compressor 4a, and a cooling medium (e.g., antifreezing fluid) flowing through a cooling medium circuit 6 so as to cool the intake air. The cooling medium circuit 6 will be described later.

On the other hand, the turbine 4b of the supercharger 4, a filter 31 and so forth are provided at the exhaust passage 3 in this order from an upstream side in an gas flow direction. The filter 31 includes a collection part that collects particulate matter, and a three-way catalyst that purifies NOx and the like, and collects particulate matter contained in exhaust gas and purifies NOx and the like.

An EGR device that recirculates a part of exhaust gas as EGR gas from an exhaust system to an intake system of the engine 1 is provided for the engine 1 of the present embodiment. The EGR device of the present embodiment is configured by a low-pressure EGR (LPL-EGR), and includes a low-pressure EGR passage 5, an EGR valve 51, and an EGR cooler 52.

The low-pressure EGR passage 5 is an EGR passage connecting together a branched part B that is located on a downstream side of the turbine 4b of the supercharger 4 and the filter 31 at the exhaust passage 3 in the gas flow direction, and a merging part A that is located on an upstream side of the compressor 4a of the supercharger 4 at the intake passage 2 in the gas flow direction.

The EGR valve 51 changes a passage sectional area of the low-pressure EGR passage 5. By changing the passage sectional area of the low-pressure EGR passage 5, a flow rate of EGR gas recirculated from the exhaust system to the intake system through the low-pressure EGR passage 5 can be adjusted. At the time of idling at which operation of the engine 1 is unstable, or at the time of maximum output of engine output, the EGR valve 51 can close the low-pressure EGR passage 5 to stop the recirculation of EGR gas to the intake system.

The EGR cooler 52 is a heat exchanger through which heat is exchanged between the EGR gas flowing through the low-pressure EGR passage 5, and the cooling medium flowing through the cooling medium circuit 6 which will be described later so as to cool the EGR gas. The EGR cooler 52 of the present embodiment is provided on a downstream side of the EGR valve 51 at the low-pressure EGR passage 5 in the gas flow direction.

The cooling medium circuit 6 will be described. The cooling medium circuit 6 is configured independently of the engine coolant circuit 10 through which the engine coolant for cooling the engine 1 flows. The cooling medium circuit 6 is a circulation circuit through which the cooling medium having temperature that is lower than the temperature of the engine coolant circulates.

In addition to the EGR cooler 52 and the intercooler 21, a cooling medium pump 61 for pressure-feeding the cooling medium, and a radiator 62 for releasing the heat of the cooling medium are connected to the cooling medium circuit 6.

The cooling medium pump 61, the EGR cooler 52, and the intercooler 21 are connected to the cooling medium circuit 6 of the present embodiment such that the cooling medium cooled by the radiator 62 flows through the cooling medium pump 61->the EGR cooler 52->the intercooler 21. Thus, the EGR cooler 52 is connected to a downstream side of the radiator 62 in a flow direction of the cooling medium such that the cooling medium which has flowed through the radiator 62 flows into the EGR cooler 52 through the cooling medium circuit 6. The intercooler 21 is connected to a downstream side of the EGR cooler 52 in the cooling medium flow direction such that the cooling medium which has flowed through the EGR cooler 52 flows into the intercooler 21 through the cooling medium circuit 6.

The operation of the exhaust gas recirculation device of the present embodiment will be explained. The air drawn into the intake passage 2 as a result of the actuation of the engine 1 is compressed by the compressor 4a of the supercharger 4 to be turned into the air with high temperature and high pressure. Then, the air exchanges heat with the cooling medium at the intercooler 21 to be cooled and supplied to the engine 1. On the other hand, the exhaust gas discharged from the engine 1 through the exhaust passage 3 flows through the turbine 4b of the supercharger 4 and is then discharged to the outside with foreign substances removed at the filter 31.

If the low-pressure EGR passage 5 is opened by the EGR valve 51, a part of exhaust gas is recirculated as the EGR gas into the intake passage 2 through the low-pressure EGR passage 5. When flowing through the low-pressure EGR passage 5, the EGR gas exchanges heat with the low-temperature cooling medium to be cooled at the EGR cooler 52, and the water contained in the EGR gas condenses at the EGR cooler 52. Accordingly, the EGR gas which has been dehumidified at the EGR cooler 52 is recirculated into the intake passage 2.

In the above-described present embodiment, the cooling medium circuit 6 which is connected to the EGR cooler 52 and the intercooler 21 is configured independently of the engine coolant circuit 10, and the intercooler 21 is connected to the downstream side of the EGR cooler 52 in the cooling medium flow direction.

Accordingly, at the EGR cooler 52, the heat exchange can be made between the EGR gas and the low-temperature cooling medium instead of the high-temperature engine coolant whose temperature is elevated in the engine 1, so that the water contained in the EGR gas can be condensed at the EGR cooler 52.

Additionally, at the intercooler 21, the heat exchange is made between the cooling medium whose temperature is elevated as a result of the absorption of heat from the EGR gas at the EGR cooler 52, and the air including the EGR gas dehumidified at the EGR cooler 52. Accordingly, the production of condensed water at the intercooler 21 can be limited.

Thus, as a result of the configuration of the present embodiment, the entry of condensed water into the engine 1, which leads to a problem at the time of low-load operation of the engine 1, can be avoided, and an occurrence of a defect caused by the condensation of water contained in the EGR gas can thereby be curbed. The low-load operation means an operating condition in which a large output is not required for the engine 1, such as in a case of traveling on a flat road or in a case of a constant speed or deceleration. A high-load operation means an operating condition in which a large output is required for the engine 1, such as in a case of traveling on a climbing lane or in a case of acceleration.

If the EGR valve 51 is provided on a downstream side of the EGR cooler 52 in the low-pressure EGR passage 5 in the gas flow direction, the EGR gas passes through the inside of the EGR cooler 52 to reach an inlet side of the EGR valve 51 due to pulsation of the engine 1, for example. Even if the low-pressure EGR passage 5 is closed by the EGR valve 51, a heat exchange may be carried out between the EGR gas and the cooling medium at the EGR cooler 52.

Particularly, when the EGR cooler 52 and the intercooler 21 are arranged in the same cooling medium circuit 6 as in the present embodiment, even though the low-pressure EGR passage 5 is closed by the EGR valve 51, the cooling medium absorbs heat from the EGR gas so that the temperature of the cooling medium rises at the EGR cooler 52, and this cooling medium whose temperature has risen flows into the intercooler 21. Accordingly, there is an issue of a deterioration in performance of cooling the air at the intercooler 21 is caused.

As a measure against this issue, in the present embodiment, there is employed a configuration in which the EGR valve 51 is provided at the low-pressure EGR passage 5 on an upstream side of the EGR cooler 52 in the gas flow direction. Accordingly, when the low-pressure EGR passage 5 is closed by the EGR valve 51, a flow of the EGR gas from the exhaust passage 3-side into the EGR cooler 52 can be prevented, and there can be prevented an unnecessary heat exchange between the EGR gas and the cooling medium at the EGR cooler 52. As a result, the deterioration in cooling performance of the intercooler 21, which is caused when the low-pressure EGR passage 5 is closed by the EGR valve 51, can be avoided.

### Second Embodiment

A second embodiment will be described. In the present embodiment, a mode of arrangement of an EGR valve 51 is different from the first embodiment. In the present embodiment, explanation will be given with the description of a part similar or equivalent to the first embodiment omitted or simplified.

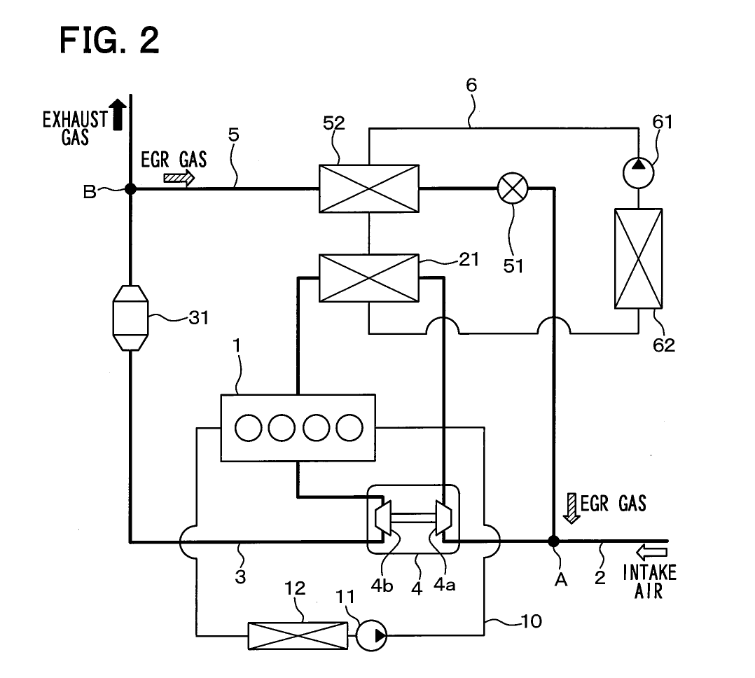

As illustrated in a general configuration diagram in FIG. 2, in the present embodiment, there is employed a configuration in which the EGR valve 51 is provided at a low-pressure EGR passage 5 on a downstream side of an EGR cooler 52 in the gas flow direction. The other configurations are similar to the first embodiment.

In the present embodiment, similar to the first embodiment, the water contained in the EGR gas can be condensed at the EGR cooler 52. Furthermore, at an intercooler 21, a heat exchange is made between the cooling medium whose temperature is elevated as a result of the absorption of heat from the EGR gas at the EGR cooler 52, and the air including the EGR gas dehumidified at the EGR cooler 52. Accordingly, the production of condensed water at the intercooler 21 can be limited.

Additionally, the present embodiment employs the configuration in which the EGR valve 51 is provided at the low-pressure EGR passage 5 on a downstream side of the EGR cooler 52 in the gas flow direction. As a consequence, the low-temperature EGR gas cooled by the EGR cooler 52 flows into near the EGR valve 51. Thus, the EGR valve 51 can be configured by a valve having low heat resistance, thereby ensuring design flexibility.

### Third Embodiment

A third embodiment will be described. In the present embodiment, explanation will be given with the description of a part similar or equivalent to the above-described embodiments omitted or simplified.

As a result of research studies by the inventors, it is found that when the water contained in the EGR gas is condensed at an EGR cooler 52 at the time of high-load operation of an engine 1 at which a flow rate of intake air is large, a defect such as liquid compression is caused at a compressor 4a of a supercharger 4.

As a factor in this defect, it can be pointed out that at the time of high-load operation of the engine 1, a flow rate of EGR gas flowing through a low-pressure EGR passage 5 increases in accordance with an increased flow rate of intake air and that the condensed water accumulated in the EGR cooler 52 thereby enters easily into an intake passage together with the EGR gas. In addition, at the time of low-load operation of the engine 1, because of a low flow rate of intake air, the entry of the condensed water accumulated in the EGR cooler 52 into the intake passage is not easily caused compared to at the time of high-load operation.

Thus, in the present embodiment, an occurrence of a defect caused at the time of high-load operation of the engine 1 is curbed by adjusting the capacity for cooling the EGR gas at the EGR cooler 52 according to a loaded condition of the engine 1.

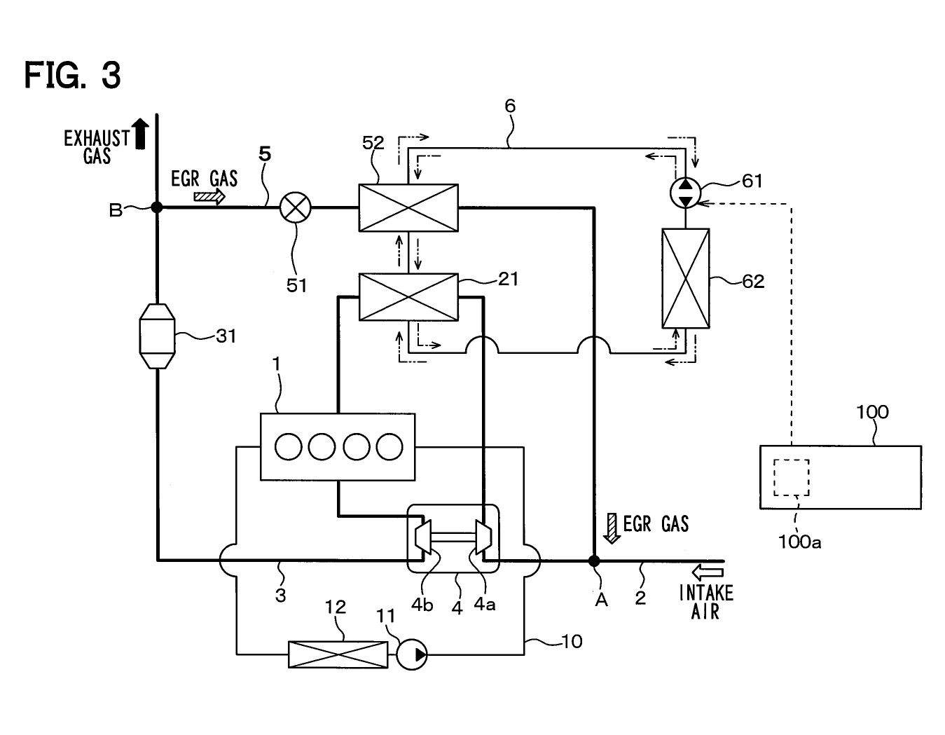

In the present embodiment, as illustrated in FIG. 3, a cooling medium pump 61 is configured by a pump (e.g., axial flow pump) that can change a flow direction of the cooling medium. Specifically, the cooling medium pump 61 is configured to be capable of changing the flow direction of the cooling medium between a flow direction in which the cooling medium flows in order of the EGR cooler 52->an intercooler 21->a radiator 62, and a flow direction in which the cooling medium flows in order of the radiator 62->the intercooler 21->the EGR cooler 52. In addition, the cooling medium pump 61 of the present embodiment is configured to change the flow direction of the cooling medium in accordance with a control signal from a control device 100.

The control device 100 includes a microcomputer having a CPU, a memory configured as a storage means, and its peripheral circuit. The control device 100 is a control means for performing various kinds of arithmetic processings based on a control program stored in the memory to control operations of various devices connected to an output side.

Various kinds of sensors such as an intake flow rate sensor (not shown) for detecting a flow rate of intake air are connected to an input side of the control device 100, and detection signals from the various kinds of sensors are inputted to the input side of the control device 100. In addition, various devices such as the cooling medium pump 61 are connected to the output side of the control device 100, and based on, for example, the detection signals from the various kinds of sensors, the output side of the control device 100 outputs the control signal to the various devices.

The control device 100 of the present embodiment is configured to be capable of determining whether the loaded condition of the engine 1 is high-load operation or low-load operation. For example, the control device 100 determines that the loaded condition of the engine 1 is high-load operation if a detection value by the intake flow rate sensor (flow rate of intake air) is a preset determination threshold value or higher, and determines that the loaded condition is low-load operation if the detection value is smaller than the determination threshold value. The determination threshold value may be set in a flow rate range of intake air assumed at the time of high-load operation.

The control device 100 of the present embodiment is configured to control the operation of the cooling medium pump 61 according to the loaded condition of the engine 1. In the present embodiment, the configuration of the control device 100 for controlling the operation of the cooling medium pump 61 constitutes a pump control means 100a.

Specifically, at the time of low-load operation of the engine 1, the control device 100 outputs to the cooling medium pump 61 a control signal for directing the cooling medium pump 61 to change the flow direction of the cooling medium such that the cooling medium which has flowed through the EGR cooler 52 flows into the intercooler 21.

Accordingly, as indicated by an alternate long and short dash line with an arrow around the cooling medium circuit 6 in FIG. 3, the cooling medium discharged from the cooling medium pump 61 flows through the EGR cooler 52->the intercooler 21->the radiator 62 in this order. In addition, at the time of low-load operation, at the EGR cooler 52, a heat exchange is made between the low-temperature cooling medium whose heat has already been released at the radiator 62, and the EGR gas.

On the other hand, at the time of high-load operation of the engine 1, the control device 100 outputs to the cooling medium pump 61 a control signal for directing the cooling medium pump 61 to change the flow direction of the cooling medium such that the cooling medium which has flowed through the intercooler 21 flows into the EGR cooler 52.

Accordingly, as indicated by an alternate long and two short dashes line with an arrow around the cooling medium circuit 6 in FIG. 3, the cooling medium discharged from the cooling medium pump 61 flows through the radiator 62->the intercooler 21->the EGR cooler 52 in this order.

In this case, at the EGR cooler 52, a heat exchange is made between the cooling medium whose temperature has risen as a result of the absorption of heat from the intake air at the intercooler 21, and the EGR gas. Accordingly, at the time of high-load operation, the capacity for cooling the EGR gas at the EGR cooler 52 is reduced compared with at the time of low-load operation.

In the present embodiment, the cooling medium pump 61, and the configuration 100a of the control device 100 for performing the control processing on the cooling medium pump 61 constitute a changing means (cooling capacity adjusting means) for changing the flow direction of the cooling medium in the cooling medium circuit 6.

The other configurations and operations are similar to the above-described first embodiment. The present embodiment employs a configuration to change the flow direction of the cooling medium by the cooling medium pump 61 such that the cooling medium which has flowed through the EGR cooler 52 flows into the intercooler 21 at the time of low-load operation of the engine 1.

Accordingly, at the intercooler 21, a heat exchange is made between the cooling medium whose temperature is elevated as a result of the absorption of heat from the EGR gas at the EGR cooler 52, and the intake air including the EGR gas dehumidified at the EGR cooler 52. As a result, the production of condensed water at the intercooler 21 can be limited. Thus, by the configuration of the present embodiment, similar to the first embodiment, the entry of condensed water into the engine 1 which leads to concerns at the time of low-load operation of the engine 1 can be averted.

Moreover, the present embodiment employs a configuration to change the flow direction of the cooling medium by the cooling medium pump 61 such that the cooling medium which has flowed through the intercooler 21 flows into the EGR cooler 52 at the time of high-load operation of the engine 1.

Accordingly, at the EGR cooler 52, a heat exchange is made between the cooling medium whose temperature has risen as a result of the absorption of heat from the intake air at the intercooler 21, and the EGR gas. As a result, the production of condensed water at the intercooler 21 can be limited.

Therefore, by the configuration of the present embodiment, the entry of condensed water into the engine 1 which leads to concerns at the time of low-load operation of the engine 1 can be averted, and the entry of condensed water into the compressor 4a of the supercharger 4 which becomes problematic at the time of high-load operation of the engine 1 can be avoided.

In this manner, as a result of the configuration of the present embodiment, an occurrence of a defect caused by the condensation of water contained in the EGR gas both at the time of low-load operation and at the time of high-load operation of the engine 1 can be curbed.

Additionally, in the present embodiment, there has been described an example of the change of the flow direction of the cooling medium in the cooling medium circuit 6 by the cooling medium pump 61. However, this is not the only mode of the present disclosure. For example, the cooling medium circuit 6 may be configured by a circuit connecting a discharge side of the cooling medium pump 61 to an inlet side of the EGR cooler 52, and a circuit connecting the discharge side of the cooling medium pump 61 to an inlet side of the radiator 62; and the cooling medium circuit 6 may be switched between the circuits according to the loaded condition of the engine 1.

### Fourth Embodiment

A fourth embodiment will be described. In the present embodiment, there will be explained an example of a modification to the third embodiment, in configuration for adjusting the capacity for cooling the EGR gas at an EGR cooler 52 at the time of high-load operation. In the present embodiment, explanation will be given with the description of a part similar or equivalent to the above-described embodiments omitted or simplified.

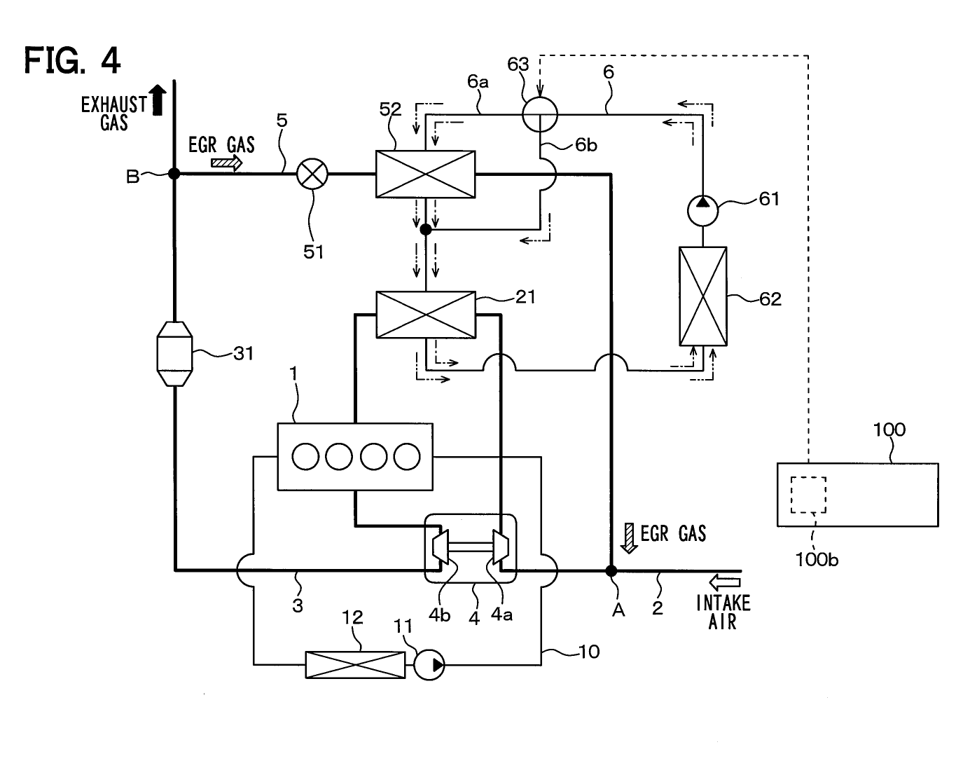

As illustrated in FIG. 4, a cooling medium circuit 6 of the present embodiment is configured to include a cooling passage 6a in which the cooling medium flows through the EGR cooler 52, and a bypass passage 6b which bypasses the EGR cooler 52 and through which the cooling medium flows.

A flow regulating valve 63 is provided at a branched part of the cooling medium circuit 6 between the cooling passage 6a and the bypass passage 6b. This flow regulating valve 63 is configured to be capable of regulating a flow rate ratio between a flow rate of the cooling medium flowing into the EGR cooler 52 through the cooling passage 6a, and a flow rate of the cooling medium flowing through the bypass passage 6b. The flow regulating valve 63 of the present embodiment is configured as an electrical three-way valve that can regulate the flow rate ratio between the cooling media through the passages 6a, 6b in response to a control signal from a control device 100.

The control device 100 of the present embodiment is configured to control the operation of the flow regulating valve 63 according to the loaded condition of an engine 1. In the present embodiment, the configuration of the control device 100 for controlling the operation of the flow regulating valve 63 serves as a flow control means 100b.

Specifically, the control device 100 outputs to the flow regulating valve 63 the control signal to command the regulation of the flow rate ratio between the cooling media through the passages 6a, 6b, such that the flow rate of the cooling medium flowing into the EGR cooler 52 at the time of high-load operation is lower than at the time of low-load operation.

For example, the control device 100 outputs to the flow regulating valve 63 the control signal to command the regulation of the flow rate ratio between the cooling media through the passages 6a, 6b, such that the entire cooling medium discharged from a cooling medium pump 61 at the time of low-load operation flows through the cooling passage 6a.

Accordingly, as indicated by an alternate long and short dash line with an arrow around the cooling medium circuit 6 in FIG. 4, the entire cooling medium discharged from a cooling medium pump 61 flows through the EGR cooler 52->an intercooler 21->a radiator 62 in this order.

On the other hand, the control device 100 outputs to the flow regulating valve 63 the control signal to command the regulation of the flow rate ratio between the cooling media through the passages 6a, 6b, such that the cooling medium discharged from the cooling medium pump 61 flows through the passages 6a, 6b at the time of high-load operation of the engine 1.

Accordingly, as indicated by an alternate long and two short dashes line with an arrow around the cooling medium circuit 6 in FIG. 4, the cooling medium discharged from the cooling medium pump 61 flows through the EGR cooler 52->the intercooler 21->the radiator 62 in this order, and bypasses the EGR cooler 52 to flow through the intercooler 21.

In this case, the flow rate of the cooling medium flowing into the EGR cooler 52 is reduced, so that the amount of heat exchanged with the EGR gas becomes small. Accordingly, at the time of high-load operation, the capacity for cooling the EGR gas at the EGR cooler 52 is reduced compared with at the time of low-load operation.

In addition, the flow rate ratio between the cooling media through the passages 6a, 6b may be regulated by the flow regulating valve 63, such that the temperature of the cooling medium at an outlet part of the EGR cooler 52 does not decrease to equal to or lower than the dew-point temperature of the cooling medium.

In the present embodiment, the flow regulating valve 63, and the configuration 100b of the control device 100 for performing the control processing on the flow regulating valve 63 serve as a flow regulating means (cooling capacity adjusting means) for regulating the flow rate of the cooling medium flowing into the EGR cooler 52 through the cooling passage 6a.

The other configurations and operations are similar to the above-described first embodiment. The present embodiment employs the configuration for regulating the flow rate ratio between the cooling media through the passages 6a, 6b by the flow regulating valve 63 such that the entire cooling medium discharged from a cooling medium pump 61 flows through the EGR cooler 52 at the time of low-load operation of the engine 1.

Accordingly, at the intercooler 21, a heat exchange is made between the cooling medium whose temperature is elevated as a result of the absorption of heat from the EGR gas at the EGR cooler 52, and the intake air including the EGR gas dehumidified at the EGR cooler 52. As a result, the production of condensed water at the intercooler 21 can be limited. Thus, by the configuration of the present embodiment, similar to the first embodiment, the entry of condensed water into the engine 1 which leads to concerns at the time of low-load operation of the engine 1 can be averted.

Furthermore, the present embodiment employs the configuration for regulating the flow rate ratio between the cooling media through the passages 6a, 6b by the flow regulating valve 63 such that the flow rate of the cooling medium flowing into the EGR cooler 52 at the time of high-load operation of the engine 1 is lower than at the time of low-load operation.

Accordingly, at the time of high-load operation of the engine 1, the amount of heat exchanged between the EGR gas and the cooling medium at the EGR cooler 52 is reduced in comparison with at the time of low-load operation, so that the capacity for cooling the EGR gas is lowered. As a result, the production of condensed water at the intercooler 21 can be restrained.

Thus, as a result of the configuration of the present embodiment, similar to the third embodiment, the entry of condensed water into the engine 1 which leads to concerns at the time of low-load operation of the engine 1 can be averted, and the entry of condensed water into the compressor 4a of the supercharger 4 which becomes problematic at the time of high-load operation of the engine 1 can be avoided.

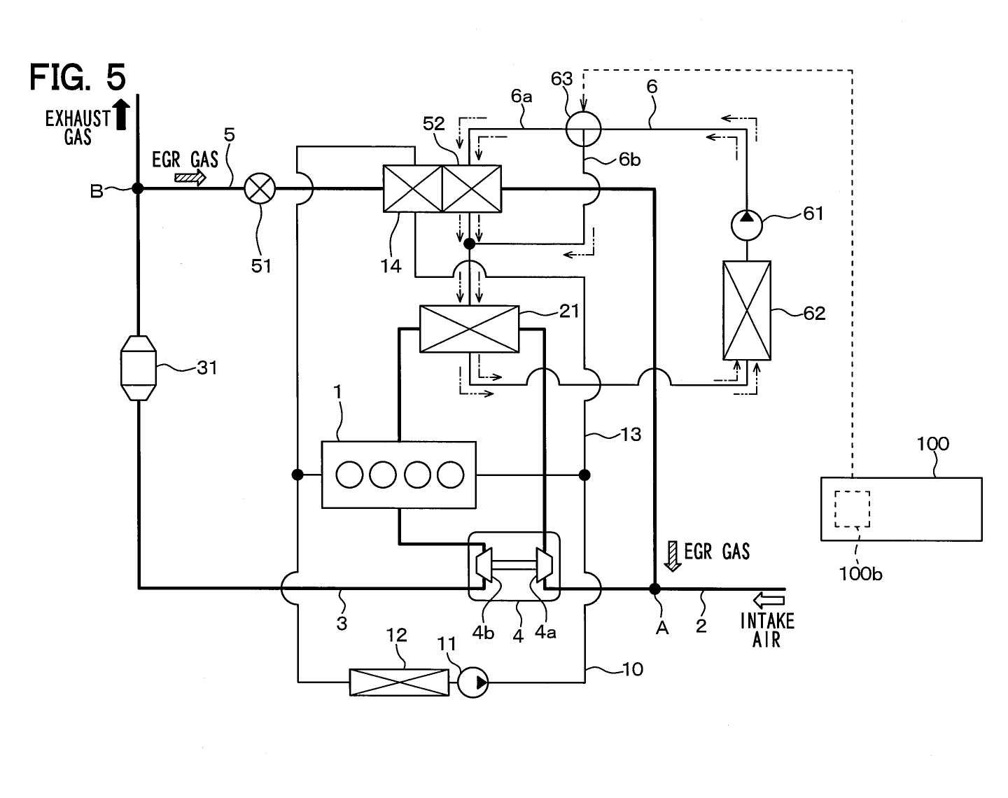

As illustrated in FIG. 5, a subcooler 14 for making a heat exchange between the high-temperature engine coolant and the EGR gas may be added at the low-pressure EGR passage 5 on an upstream side of the EGR cooler 52 in a flow direction of the EGR gas.

Accordingly, the EGR gas can be cooled by both the EGR cooler 52 and the subcooler 14, and the water contained in the EGR gas can thereby be condensed appropriately at the EGR cooler 52 at the time of low-load operation. Additionally, at the time of high-load operation, the amount of heat exchanged between the EGR gas and the cooling medium at the EGR cooler 52 is reduced in comparison with at the time of low-load operation, so that the entry of condensed water into an intake passage 2 can be inhibited.

In the present embodiment, there has been described an example of the regulation of the flow rate ratio between the cooling media through the passages 6a, 6b by the flow regulating valve 63 such that the entire cooling medium flows through the cooling passage 6a at the time of low-load operation. However, this is not the only example of the present disclosure. As long as the flow rate of the cooling medium flowing into the EGR cooler 52 at the time of high-load operation is lower than at the time of low-load operation, the flow rate ratio between the cooling media through the passages 6a, 6b by the flow regulating valve 63 may be regulated, for example, such that a part of the cooling medium flows through the bypass passage 6b at the time of low-load operation.

In the present embodiment, there has been described an example of the flow regulating valve 63 being provided at the branched part of the cooling medium circuit 6 between the cooling passage 6a and the bypass passage 6b. However, this is not the only example of the present disclosure. For example, the flow regulating valve 63 may be provided at a merging part in the cooling medium circuit 6 between the cooling passage 6a and the bypass passage 6b.

### Fifth Embodiment

A fifth embodiment will be described. In the present embodiment, there will be explained an example of a modification to the third and fourth embodiments, in configuration for adjusting the capacity for cooling the EGR gas at an EGR cooler 52 at the time of high-load operation. In the present embodiment, explanation will be given with the description of a part similar or equivalent to the above-described embodiments omitted or simplified.

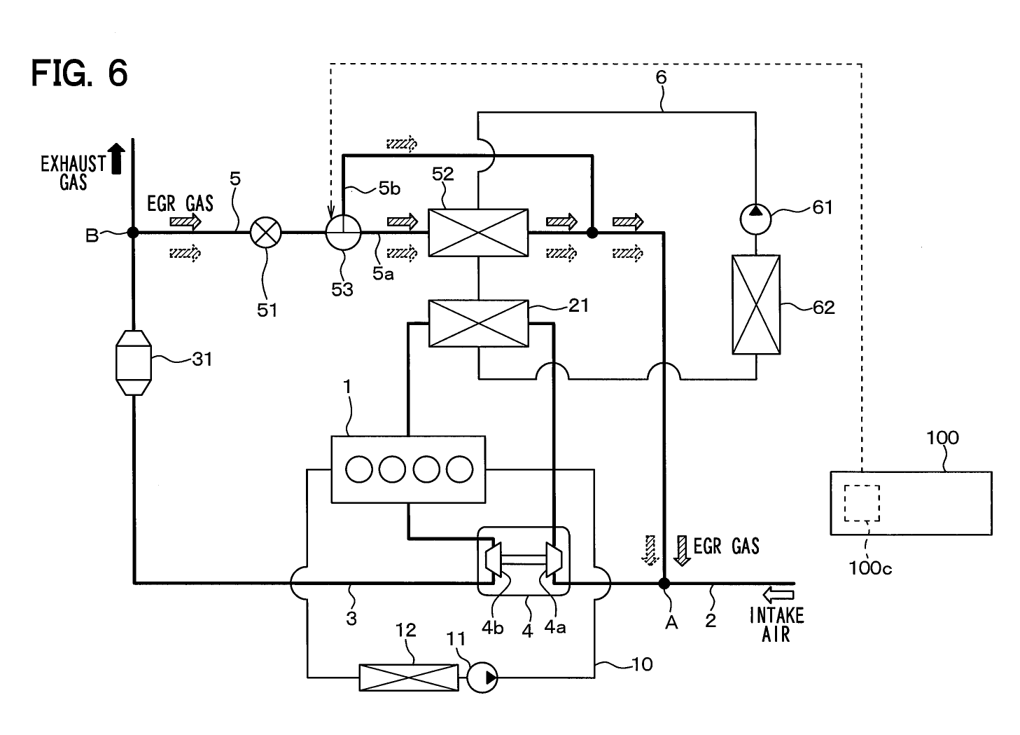

As illustrated in FIG. 6, a low-pressure EGR passage 5 of the present embodiment is configured to include a gas passage 5a through which the EGR gas flows into the EGR cooler 52, and a bypass passage 5b through which the EGR gas bypasses the EGR cooler 52.

A gas flow regulating valve 53 is provided at a branched part of the low-pressure EGR passage 5 between the gas passage 5a and the bypass passage 5b. This gas flow regulating valve 53 is configured to be capable of regulating a flow rate ratio between a flow rate of the EGR gas flowing into the EGR cooler 52 through the gas passage 5a, and a flow rate of the EGR gas flowing through the bypass passage 5b. The gas flow regulating valve 53 of the present embodiment is configured as an electrical three-way valve that can regulate the flow rate ratio between the EGR gas through the passages 5a, 5b in response to a control signal from a control device 100.

The control device 100 of the present embodiment is configured to control the operation of the gas flow regulating valve 53 according to the loaded condition of an engine 1. In the present embodiment, the configuration of the control device 100 for controlling the operation of the gas flow regulating valve 53 serves as a gas flow control means 100c.

Specifically, the control device 100 outputs to the gas flow regulating valve 53 the control signal to command the regulation of the flow rate ratio between the EGR gas through the passages 5a, 5b, such that the flow rate of the EGR gas flowing into the EGR cooler 52 at the time of high-load operation is lower than at the time of low-load operation.

For example, the control device 100 outputs to the gas flow regulating valve 53 the control signal to command the regulation of the flow rate ratio between the EGR gas through the passages 5a, 5b, such that the entire EGR gas flowing into the low-pressure EGR passage 5 flows through the gas passage 5a at the time of low-load operation.

Accordingly, as indicated by an arrow of a continuous line around the low-pressure EGR passage 5 in FIG. 6, the entire EGR gas flowing into the low-pressure EGR passage 5 flows into the EGR cooler 52 through the gas passage 5a.

On the other hand, the control device 100 outputs to the gas flow regulating valve 53 the control signal to command the regulation of the flow rate ratio between the EGR gas through the passages 5a, 5b such that the EGR gas flowing into the low-pressure EGR passage 5 flows through the passages 5a, 5b at the time of high-load operation of the engine 1.

Accordingly, as indicated by an arrow of a short dashes line around the low-pressure EGR passage 5 in FIG. 6, the EGR gas flowing into the low-pressure EGR passage 5 flows into the EGR cooler 52 through the gas passage 5a, and flows through the bypass passage 5b to bypass the EGR cooler 52.

In this case, at the EGR cooler 52, the flow rate of the EGR gas flowing into the EGR cooler 52 is lowered, and the amount of heat exchanged with the cooling medium thereby becomes small. Accordingly, at the time of high-load operation, the capacity for cooling the EGR gas at the EGR cooler 52 is reduced compared with at the time of low-load operation.

In addition, the flow rate ratio between the cooling media through the passages 5a, 5b may be regulated by the gas flow regulating valve 53, such that the temperature of the cooling medium at an outlet part of the EGR cooler 52 does not decrease to equal to or lower than the dew-point temperature of the cooling medium.

In the present embodiment, the gas flow regulating valve 53, and the configuration 100c of the control device 100 for performing control processing on the gas flow regulating valve 53 serve as a gas flow regulating means (cooling capacity adjusting means) for regulating the flow rate of the EGR gas flowing into the EGR cooler 52 through the gas passage 5a.

The other configurations and operations are similar to the above-described first embodiment. The present embodiment employs the configuration for regulating the flow rate ratio between the EGR gas through the passages 5a, 5b by the gas flow regulating valve 53, such that the entire EGR gas flowing into the low-pressure EGR passage 5 flows through the EGR cooler 52 at the time of low-load operation of the engine 1.

Accordingly, at an intercooler 21, a heat exchange is made between the cooling medium whose temperature is elevated as a result of the absorption of heat from the EGR gas at the EGR cooler 52, and the intake air including the EGR gas dehumidified at the EGR cooler 52. As a result, the production of condensed water at the intercooler 21 can be limited. Thus, by the configuration of the present embodiment, similar to the first embodiment, the entry of condensed water into the engine 1 which leads to concerns at the time of low-load operation of the engine 1 can be averted.

Moreover, the present embodiment employs the configuration for regulating the flow rate ratio between the EGR gas through the passages 5a, 5b by the gas flow regulating valve 53, such that the flow rate of the EGR gas flowing into the EGR cooler 52 at the time of high-load operation of the engine 1 is lower than at the time of low-load operation.

Accordingly, at the time of high-load operation of the engine 1, the amount of heat exchanged between the EGR gas and the cooling medium at the EGR cooler 52 is reduced in comparison with at the time of low-load operation, and the capacity for cooling the EGR gas is thereby reduced. As a result, the production of condensed water at the intercooler 21 can be restrained.

Thus, as a result of the configuration of the present embodiment, similar to the third and fourth embodiments, the entry of condensed water into the engine 1 which leads to concerns at the time of low-load operation of the engine 1 can be averted, and the entry of condensed water into a compressor 4a of a supercharger 4 which becomes problematic at the time of high-load operation of the engine 1 can be avoided.

In the present embodiment, there has been described an example of the regulation of the flow rate ratio between the EGR gas through the passages 5a, 5b by the gas flow regulating valve 53 such that the entire EGR gas flows through the gas passage 5a at the time of low-load operation. However, this is not the only example of the present disclosure. As long as the flow rate of the EGR gas flowing into the EGR cooler 52 at the time of high-load operation is lower than at the time of low-load operation, the flow rate ratio between the EGR gas through the passages 5a, 5b by the gas flow regulating valve 53 may be regulated, for example, such that a part of the EGR gas flows through the bypass passage 5b at the time of low-load operation.

In the present embodiment, there has been described an example of the gas flow regulating valve 53 being provided at the branched part of the low-pressure EGR passage 5 between the gas passage 5a and the bypass passage 5b. However, this is not the only example of the present disclosure. For example, the gas flow regulating valve 53 may be provided at a merging part in the low-pressure EGR passage 5 between the gas passage 5a and the bypass passage 5b.

Modifications to the above embodiments will be described below.

The embodiments have been described above. However, the present disclosure is not limited to these, and can be modified in a variety of modes without departing from the scope of the disclosure. For example, the disclosure can be modified as follows.

(1) In the above-described embodiments, there has been explained an example of only the low-pressure EGR provided as the EGR device. However, this is not the only example. For example, the present disclosure may be applied to a device including both a low-pressure EGR and a high-pressure EGR (HPL-EGR) as the EGR device.

(2) In the above-described embodiments, there has been explained an example of the engine 1 configured as a gasoline engine. However, this is not the only example. A diesel engine can also be employed.

(3) The above-described embodiments can be appropriately combined together unless they are independent of one another or the combination is clearly impossible.

(4) In the above-described embodiments, it goes without saying that the elements that constitute the embodiment are not necessarily essential, for example, unless it is clearly specified that they are particularly essential or it is believed that they are obviously essential in principle.

(5) In the above-described embodiments, when the numerical value for the number of components, the numerical value, the amount, or the range of the embodiment, for example, is mentioned, unless it is clearly specified that they are particularly essential or it is obviously limited to a specified number in principle, for example, the numerical value is not limited to this specified number.

(6) In the above-described embodiments, when the shape or positional relationship of the component or the like is mentioned, unless it is particularly specified clearly or it is limited to a specified shape or positional relationship in principle, for example, the component is not limited to that shape or positional relationship.

While the present disclosure has been described with reference to embodiments thereof, it is to be understood that the disclosure is not limited to the embodiments and constructions. The present disclosure is intended to to cover various modification and equivalent arrangements. In addition, while the various combinations and configurations, other combinations and configurations, including more, less or only a single element, are also within the spirit and scope of the present disclosure.

1. An exhaust gas recirculation (EGR) device for an internal combustion engine, comprising:
an EGR passage through which a part of exhaust gas flowing through an exhaust passage of the engine is recirculated as EGR gas into an intake passage of the engine;
a cooling medium circuit through which a cooling medium flows;
an EGR cooler that performs a heat exchange between EGR gas flowing through the EGR passage and the cooling medium flowing through the cooling medium circuit so as to cool EGR gas; and
an intercooler that is disposed at the intake passage on a downstream side of a merging part between the intake passage and the EGR passage in a flow direction of intake air and that performs a heat exchange between intake air including EGR gas and flowing through the intake passage, and the cooling medium flowing through the cooling medium circuit so as to cool intake air, wherein:
the cooling medium circuit is configured independently from a coolant circuit through which coolant for cooling the engine flows; and
the cooling medium circuit is configured such that at least at time of low-load operation of the engine, the cooling medium which has passed through the EGR cooler flows into the intercooler.

2. The EGR device according to claim 1, further comprising a supercharger including a compressor that is provided at the intake passage and a turbine that is provided at the exhaust passage, wherein:
air compressed by the compressor flows into the intercooler;
the EGR passage is connected to a portion of the intake passage that is on an upstream side of the compressor in the flow direction of intake air; and
the EGR passage is connected to a portion of the exhaust passage that is on a downstream side of the turbine in a flow direction of exhaust gas.

3. The EGR device according to claim 2, further comprising a cooling capacity adjusting means for adjusting a capacity for cooling EGR gas by the EGR cooler, wherein at time of high-load operation of the engine, the cooling capacity adjusting means reduces the capacity for cooling EGR gas by the EGR cooler as compared to at the time of low-load operation.

4. The EGR device according to claim 3, wherein:
the cooling capacity adjusting means includes a changing means for changing a flow direction of the cooling medium through the cooling medium circuit;
the changing means changes the flow direction of the cooling medium such that the cooling medium which has passed through the EGR cooler flows into the intercooler at the time of low-load operation; and
the changing means changes the flow direction of the cooling medium such that the cooling medium which has passed through the intercooler flows into the EGR cooler at the time of high-load operation.

5. The EGR device according to claim 3, wherein:
the cooling medium circuit includes a cooling passage in which the cooling medium flows through the EGR cooler, and a bypass passage through which the cooling medium flows to bypass the EGR cooler;
the cooling capacity adjusting means includes a flow regulating means for regulating a flow rate of the cooling medium flowing into the cooling passage; and
the flow regulating means regulates the flow rate of the cooling medium flowing into the cooling passage such that a flow rate of the cooling medium flowing through the cooling passage at the time of high-load operation is lower than a flow rate of the cooling medium flowing through the cooling passage at the time of low-load operation.

6. The EGR device according to claim 5, further comprising a subcooler that performs a heat exchange between EGR gas flowing through the EGR passage and coolant flowing through the coolant circuit so as to cool EGR gas, wherein the subcooler is disposed on an upstream side of the EGR cooler at the EGR passage in a flow direction of EGR gas.

7. The EGR device according to claim 3, wherein:
the EGR passage includes a gas passage in which EGR gas flows through the EGR cooler, and a bypass passage through which EGR gas flows to bypass the EGR cooler;
the cooling capacity adjusting means includes a gas flow regulating means for regulating a flow rate of EGR gas flowing into the gas passage; and
the gas flow regulating means regulates the flow rate of EGR gas flowing into the gas passage such that a flow rate of EGR gas flowing through the gas passage at the time of high-load operation is lower than a flow rate of EGR gas flowing through the gas passage at the time of low-load operation.

8. The EGR device according to claim 1, further comprising an EGR valve that changes a cross-sectional area of the EGR passage, wherein the EGR cooler is provided on a downstream side of the EGR valve at the EGR passage in a flow direction of EGR gas.

9. The EGR device according to claim 1, further comprising a radiator that releases heat of the cooling medium, wherein the EGR cooler is connected to a downstream side of the radiator in a flow direction of the cooling medium such that the cooling medium which has passed through the radiator flows into the EGR cooler.
